(19) United States
(12) Patent Application Publication
(10) Pub. No.: US 2017/0119068 A1
(43) Pub. Date: May 4, 2017

(54) INTEGRATED LEG GUARDS

(71) Applicant: Holdt Products, LLC, Springfield, MO (US)

(72) Inventor: Tom Beckenholdt, Springfield, MO (US)

(21) Appl. No.: 15/336,787

(22) Filed: Oct. 28, 2016

Related U.S. Application Data
(60) Provisional application No. 62/248,069, filed on Oct. 29, 2015.

(51) Int. Cl. A41D 13/05; A62B 17/00; A41D 31/00; A43B 3/02; A41D 13/06

(52) U.S. Cl. CPC A41D 13/0568; A43B 3/02; A41D 13/0543; A41D 13/065; A41D 31/0022; A62B 17/003

(57) ABSTRACT

A leg guard is described that is releaseably and adjustably attached to a boot, such as a firefighter's boot, for protection to the lower leg of a wearer from impacts and other injury. The leg guard is capable of being attached to the turnout gear of a firefighter so that the leg guard may be donned as part of the turnout gear without additional attachment to the leg of the user. In the preferred embodiment, the leg guard has a padded shin guard and separate knee cup that articulates with the user's leg during movement. An adjustable clip is used to connect the leg guard to the top of the boot.

### CROSS REFERENCE TO RELATED APPLICATION

This application claims the benefit of priority to U.S. Provisional Patent Application No. 62/248,069filed Oct. 29, 2015, which is incorporated by reference herein in its entirety.

### FIELD OF THE INVENTION

The integrated leg guards described herein relate to protective leg guards that may be worn to protect the knee and shin from injury due to impact trauma to the lower leg or pain due to kneeling, crawling or similar activity. The leg guards are removably attached to boots or shoes. More specifically, some embodiments are directed to leg guards for protecting the lower legs of firefighters from injury during firefighting operations.

### SUMMARY OF THE INVENTION

In various embodiments, the leg guards disclosed herein are configured for attachment to boots, such as firefighter's boots. Each leg guard has an impact shell component that is made of a shin guard section and a knee cup section. The knee cup section is located above the shin guard section, and is contoured to substantially fit around the knee and lower leg of a user. A pad is attached to the inside surface of the impact shell component to cushion the users legs. An attachment strap is attached to the shin guard section adjacent to the lower end such that it is close to the upper portion of the boot, and it is preferably securable around the boot to maintain the proximity of the shin guard to the boot during use. An attachment clip is releaseably attached to the shin guard section and is used to attach the shin guard section to the top edge of a boot. In some embodiments, the shin guard section has a series of mounting holes for releaseably attaching the attachment clip to the shin guard to allow for adjustment of the height of the leg guard. In some embodiments the pad incorporates edging and thread formed using fire-resistant materials.

### BRIEF DESCRIPTION OF THE DRAWINGS

FIG. 1 is a perspective view of an embodiment of the leg guard attached to a boot.

FIG. 2 is a front view of an embodiment of the leg guard.

FIG. 3 is side view of an embodiment of the leg guard.

FIG. 4 is rear perspective view of an embodiment of the leg guard attached to a boot.

FIG. 5 is a rear view of an embodiment of the leg guard of the present invention.

FIG. 6 is a perspective view of an embodiment of the leg guard of the present invention.

FIG. 7 is a perspective view of an embodiment of the attachment clip of the leg guard of the present invention attached to a boot.

FIG. 8 is a cross-sectional view of a portion of an embodiment of the leg guard of the present invention.

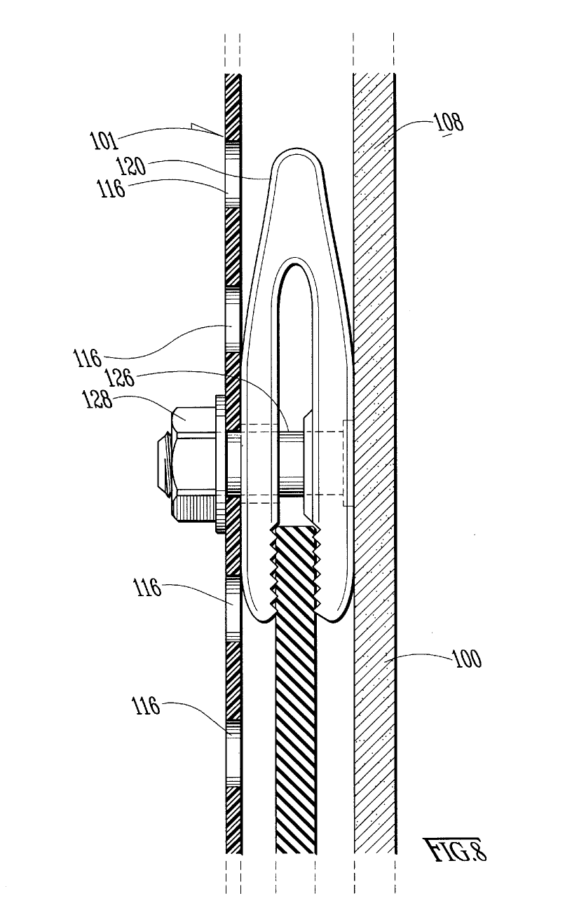

FIG. 9 is a partial exploded view of an embodiment of the connection assembly of the leg guard of the present invention.

### DETAILED DESCRIPTION

The integrated leg guard as disclosed in reference to the embodiments depicted in the figures provides a leg guard for use in conjunction with a boot or similar footwear. The leg guard is capable of removeable attachment to the boot to be part of an integrated unit for quick and easy donning of the leg guard simultaneously with the boot. In some embodiments, the leg guard is attached to the boot of a firefighter as part of the firefighter's turnout gear so that the leg guard is automatically donned by the firefighter with the turnout gear. No separate straps to attach the leg guard to the legs of a user are required. The connection points all relate to the attachment of the leg guard to the user's boot.

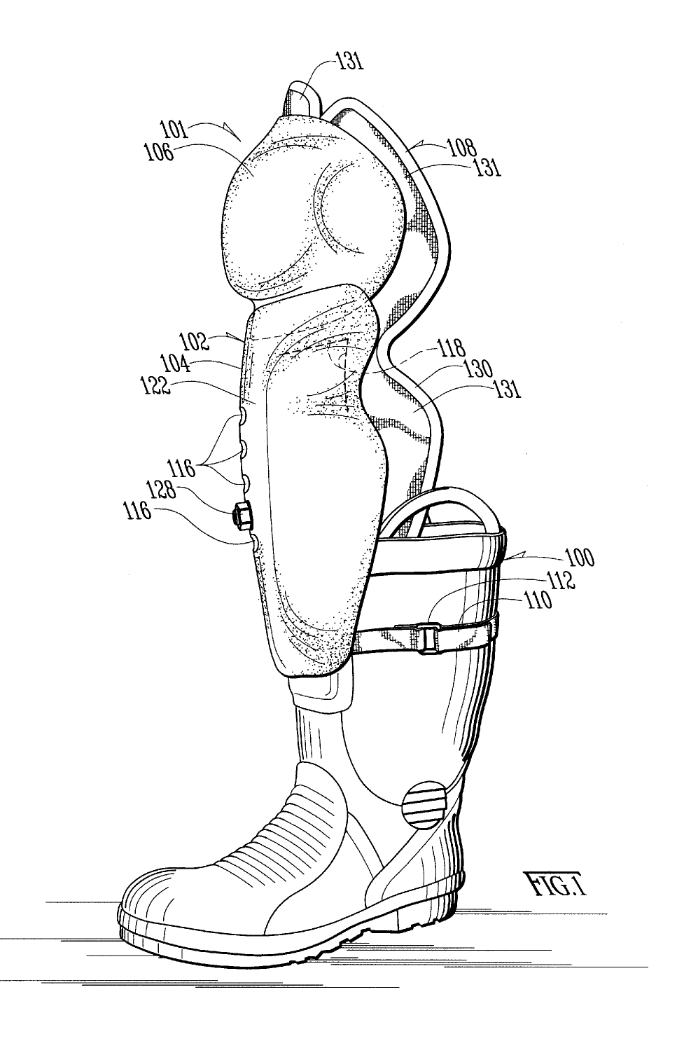

With reference to FIG. 1, a perspective view of the innovative leg guard is depicted attached to a boot 100. The leg guard 102 comprises an impact shell component 101 made of a shin guard section 104 and a knee cup section 106. The shin guard section 104 and the knee cup section 104 may be a single element or made separately and later joined together by conventional means. The impact section 101 may be rigid or flexible in various applications, but is formed from a material designed to protect the leg of the wearer from impacts.

The shin guard 104 and the knee cup 106 are manufactured to form a rigid material that is sufficiently strong to protect the leg from impact. In some embodiments, the shin guard 104 and knee cup 106 are made from a Polycarbonate/Acrylonitrile-Butadiene-Styrene polymer blend. The knee cup 104 is contoured in a rough hemispherical or dome shape to approximate the shape of and cover the knee cap of a user. Similarly, the shin guard 106 is contoured into a rough semi-cylindrical shape to approximate the shape of and cover the shin of a user.

In some embodiments, the shin guard 104 and the knee cup 106 may be made from a material selected to withstand specific conditions, such as high heat, chemical exposure, or other environmental hazards. In various embodiments, the shin guard 104 and knee cup 106 may be manufactured by injection molding, vacuum molding, rotational molding, or other types of molding. In one embodiment of the leg guard, the shin guard 104 and knee cup 106 are about 3/16 inches thick although material thickness may vary. As described below, pad 108 and attachment strap 110 are attached to the rigid component 101.

In some embodiments of the leg guard, the attachment point between the leg guard and the boot is adjustable to fit the user wearing the integrated system. In one embodiment, a plurality of ½ inch holes 116 are provided in the impact shell 101 as attachment points for receiving an attachment clip 120 that also attaches to the boot. In other embodiments, the attachment clip 120 may attach to the inside of the shin guard 106 without holes 116, but via another method of attachment such as machine screws, clasps, snap lock or other types of buckles, or any other known method of attachment, such method not being limiting of the leg guard. In some embodiments, the clip may be formed as part of the impact shell, and more than one clip may be provided to allow for adjustment of the attachment point to the boot. In some embodiments, the boot is provided with a feature for receiving the attachment clip 120.

The attachment clip 120 may be manufactured in a variety of forms to those known in the art and be within the scope of the present invention. In the depicted embodiment, the clip is bolted to the shin guard 106 by a bolt inserted through one of the plurality of holes 116 and the clip 120 and then secured with a nut. In the depicted embodiment, the attachment clip 120 extends downwardly to sandwich a portion of boot 101 between the shin guard 106 and the clip 120. In other embodiments, the clip 120 may attach to the top of boot 100 using jaws or other types of fasteners. The specific type of fastener used to attach the shin guard 106 to the boot 100 is not limiting of the inventive leg guard.

In some embodiments, the clip 120 may attach to the shin guard 106 at a variety of locations disposed vertically along the inside thereof. This allows a user to adjust the attachment point for the type of footwear to which the guard is attached and for the length of the user's lower leg.

One or more pads 108 may be attached to the inside surface of the shin guard 104 and the knee cup 106. The pads 108 are designed to cushion the leg of a user from impacts on the shin guard 104 and knee cup 106, and to prevent injury to the user from such impacts. The pads 108 also allows a user to wear the leg guards 102 when kneeling and crawling without significant discomfort or injury to the user. One of the common injuries experience by firefighters occurs when they are crawling on a floor and impact their leg on debris on the floor. The rigid material in the shin guard 104 and knee cup 106, and the pads 108 substantially eliminate such injuries.

In some embodiments, the padding is manufactured from ¼ inch closed cell silicone sponge material. In some embodiments the pad 108 comprises one or more separate pads attached to the shin guard 104 or knee cup 106. In some embodiments of the leg guard, the pads 108 are covered or lined with a material such as Nomex. In other embodiments pad 108 may be provided with Nomex edging 130 and attached to the shin guard 104 and knee cup 106 by stitches 118 which may also be made using Nomex thread. In some embodiments other flame, heat or chemical resistant materials may be used for the cover, edging, and stitches.

As shown in FIG. 1, the leg guard 102 is removabley attached to boot 100. Preferably, the top front edge of boot 100 extends between pad 108 and shin guard 104. Attachment strap 110 is attached to the surface of shin guard 104 and extends around the outside of boot 100 and is then fastened using attachment material 112. The strap 110 and clip 120 hold the shin guard 104 in position above boot 100 even when the boot 100 is not being worn by a user. The pad 108 extends inside the top front edge of boot 100.

Some embodiments of the leg guards are intended to be worn inside pants such as firefighter turnout gear pants. The leg guards may be left attached to the boot when not in use, and then a user may don the leg guards simply by stepping into the boots, and then pulling the pants up over the leg guards. This substantially decreases the amount of time normally taken to dress with the leg guards, boots and turnout gear if donned separately.

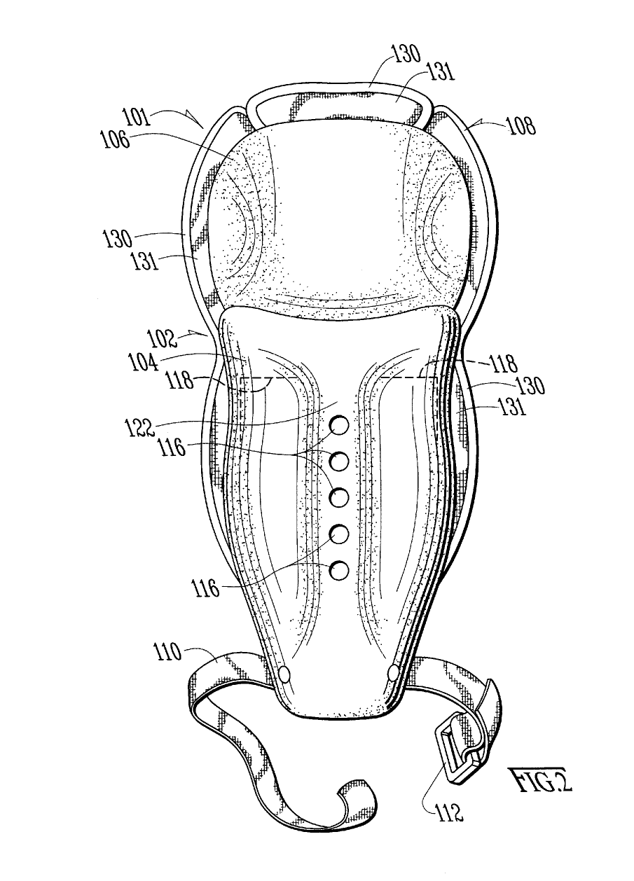

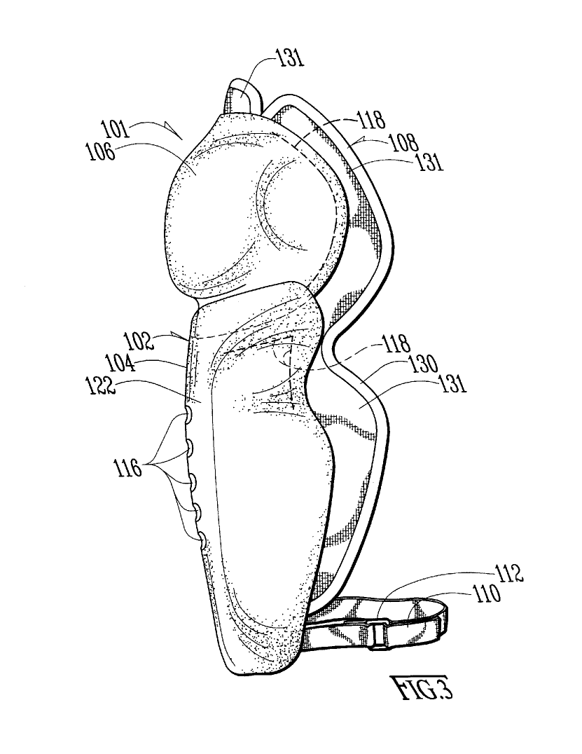

Referring now to FIG. 2 and 3, a front and a side view, respectively, of an embodiment of the leg guard 102 is depicted. In some embodiments, the shin guard 104 is provided with an optional support rib running vertically down the shin guard 104. The support rib 122 may comprise an extension from the adjacent areas of the shin guard 104 and stiffens the shin guard 104. The support rib 122 may be a thickened area of shin guard 106 or a contour in a shin guard having a uniform thickness. In some embodiments, the support rib 122 may be 1.25 inches wide. In other embodiments the support rib 122 may have extensions running horizontally toward the edges of shin guard 106, may be wider or narrower than depicted, or may vary in dimension along its length. In some embodiments the support rib may be the location of the adjustable mounting means for the attachment clip 120, as shown for this embodiment as mounting holes 116 for receiving an attachment clip 120.

In some embodiments, the leg guard 102 extends approximately 16 inches from the bottom of the shin guard 104 to the top of the knee cup 106. In some embodiments, the knee cup may be approximately 6.5 inches wide and approximately 5.5 inches from the top of the knee cup to the bottom of the knee cup. In some embodiments, the shin guard is 11.5 inches from the top to the bottom thereof. The shin guard 106 and knee cup 104 may vary in width and contour along their length and breadth.

Attachment strap 110 may be attached to shin guard 104 by stitches 124 which may be made using Nomex thread. An area of hook and loop material 124, or similar materials, may be provide on strap 110, and buckle 112 may be provided on the other end of strap 110. In some embodiments, strap 110 is fed through buckle 112 and folded back on itself, pulled tight and then secured by engaging area 124 on itself or on another section of hook and loop or similar material.

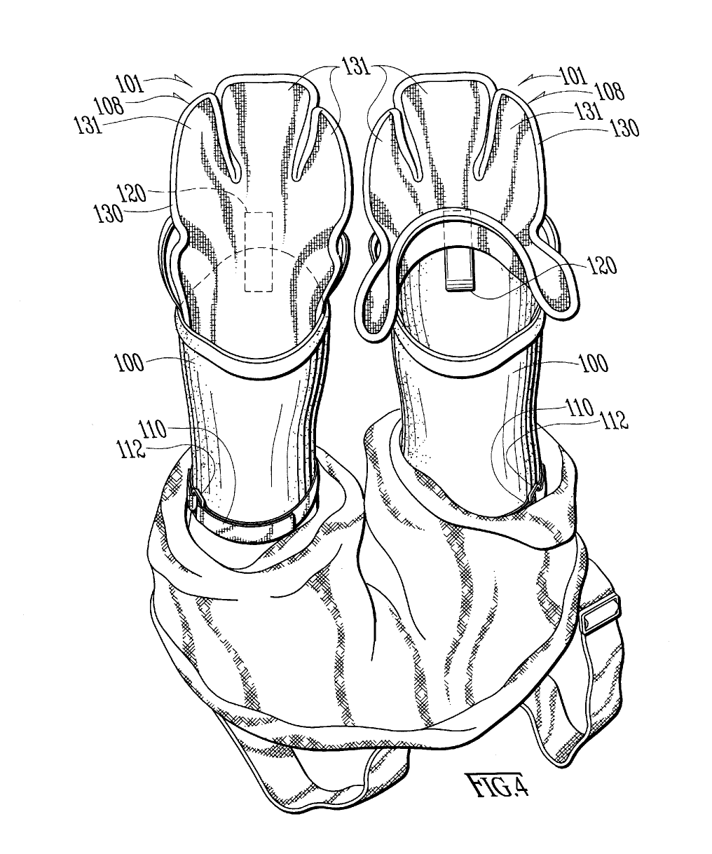

Referring now to FIG. 4, a rear perspective view of an embodiment of the leg guard is shown attached to a boot. This figure depicts a pair of pants disposed around the boots and ready for donning over the leg guards. In the depicted embodiment, an attachment clip 120 is provided for securing the leg guard to the boot 100. The clip 120 releaseably attaches to the top edge of boot 100 or secures the top of the boot 100 between the shin guard 104 and clip 120. In some embodiments, the clip 120 is provided with means of releaseably attaching to the inside surface of the shin guard 104. The clip 120 may attached to the shin guard by a variety of attachment means, including without limitation, a nut and bolt for inserting through mounting holes 116 and securing the attachment clip 120 to shin guard 104. A series of mounting holes 116 may be provided to allow the adjustment of the location of knee cup 106 in relation to the boot to fit a particular user.

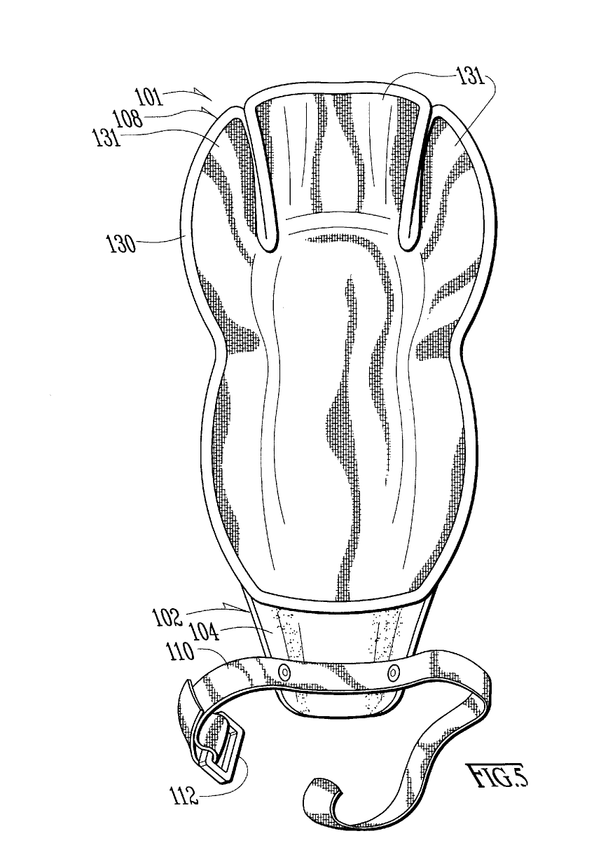

Referring now to FIG. 5, a rear view of an embodiment of the leg guard is depicted. Edging 130, of Nomex or other desired material is clearly visible on pad 108. The varying lobes 131 of pad 108 may be seen to allow for contouring of the pad 108 to the inside surface of section 101. The specific configuration of lobes in pad 108 is not limiting of the invention, and other shapes and configurations of pad 108 may be used on the leg guard as described and claimed herein.

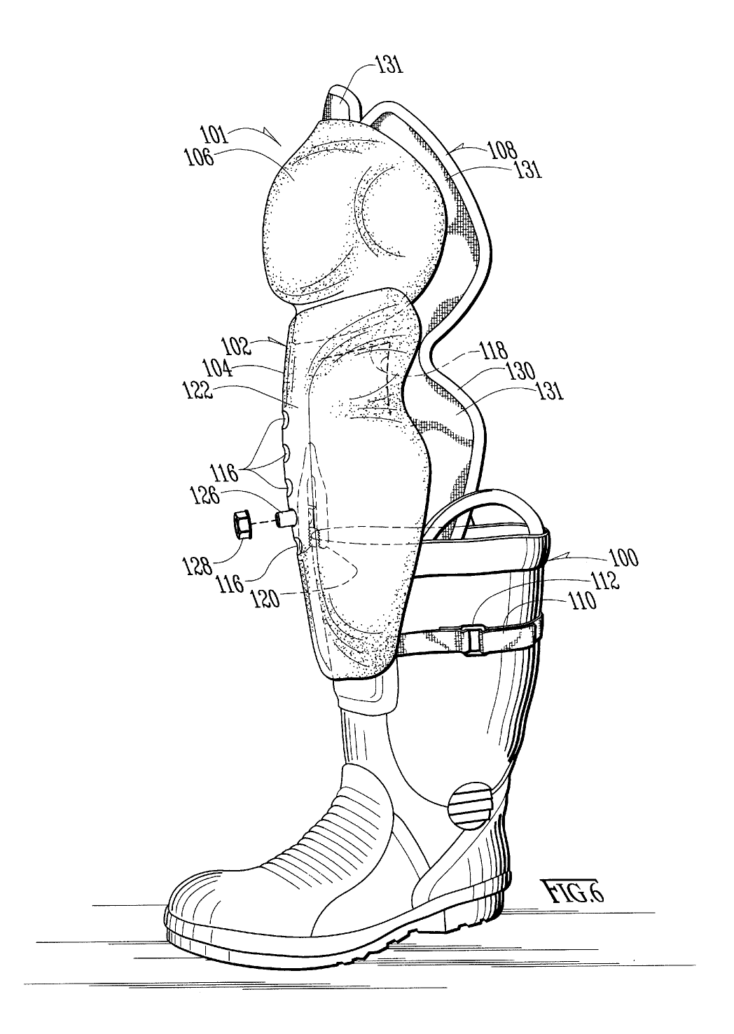

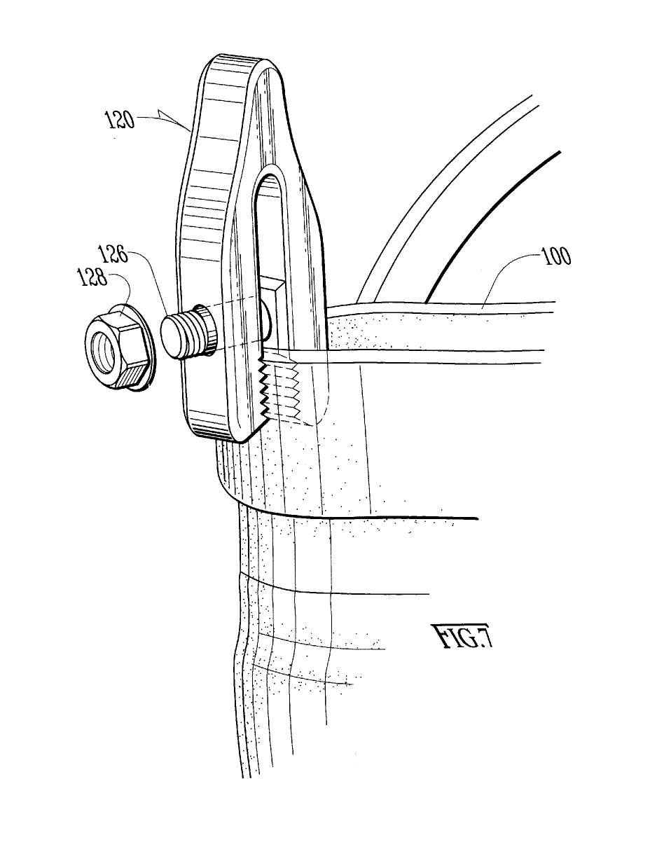

Referring now to FIG. 6, 7, and 8, perspective view and cross-section views of an embodiment of the leg guard are depicted. FIG. 7 shows the attachment clip 120 with the pad 108 and the impact shell 101 removed for purposes of clarity. In some embodiments of the leg guard, clip 120 has two jaws that are disposed on opposite sides of the upper edge of the boot 100 and secured together by bolt 126 and nut 128 which squeeze the jaws together on either side of the upper edge of boot 100. In the depicted embodiment, bolt 126 extends through one of the mounting holes 116 in impact shell 101. Nut 128 is secured to bolt 126 from the outside of impact shell 101, thus securing the attachment clip 120 to the leg guard and also squeezing the jaws of clip 120 to secure it to the boot 100. In other embodiments of the leg guard, entirely different designs of clip 120 or methods of releaseably attaching the leg guard to the boot may be utilized.

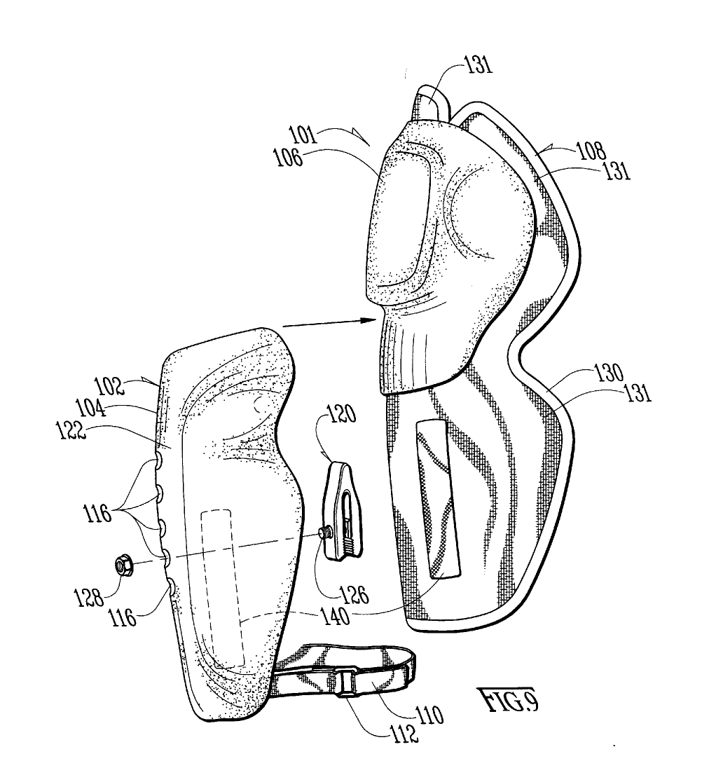

In another embodiment, the attachment clip is not attached to the impact shell, but may be attached to the pad 108 as shown in FIG. 9. Further, the knee cup 106 may be formed separately from the shin guard 104 so that the two pieces articulate separately as the user moves. Hook and loop fasteners 140 may be used to connect the lower portion of the knee cup 106 to the upper portion of the shin guard 104 which also creates some vertical adjustment between the two pieces. Alternatively, the hook and loop 140 fastener can be used to connect the shin guard 104 to the pad 108. In some embodiments, one or more tabs are provided on the portion of the pad 108 that extends into the boot 100. In some embodiments, the boot 100 may be provided with slots on the inside, outside or top edge of the boot to receive the tabs on the pad 108. In other embodiments, the tabs may be provided on the portion of the impact shell 101 that overlaps boot 100, and the slots may be provide on the exterior or interior surface of the boot, or on its top edge. In some other embodiments, one or more slots may be provided on the impact shell 101 for receiving tabs incorporated into the boot 100. In some embodiments the tab is provided with a catch for engaging a feature on the slot to prevent undesired release of the leg guard from the boot. As best shown in FIG. 9, the knee cup 106 may have a substantially flat outer surface which increases stability and comfort of the user when crawling.

Other types of connections between the boot and leg guard may be utilized within the scope of the invention. For example, quick release buckles, receptacles on the boot or shell for receiving mounting posts on the other component, keyhole fasteners, snaps or other similar means of attaching the pad or shell to the boot may be used instead of or in addition to the clamp, tabs and slots, or other mechanisms. Any of these mechanisms may be provided with latches, catches or similar mechanisms for securing the attachment to prevent undesired separation of the leg guard from the boot.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A leg guard for attachment to a boot comprising:
an impact shell component comprising a shin guard section and a knee cup section, wherein the knee cup section is above the shin guard component;
at least one pad attached to the inside surface of the impact shell component;
an attachment strap attached to the shin guard section adjacent to the lower end thereof;
an attachment clip releaseably attached to the shin guard section for attaching the shin guard section to a top edge of the boot.

2. The leg guard of claim 1, wherein the shin guard section further comprises a series of mounting holes for releaseably attaching the attachment clip to the shin guard.

3. The leg guard of claim 1, wherein the pad further comprises edging formed using fire-resistant materials.

4. The leg guard of claim 3, wherein the pad is attached to the impact shell component using fire-resistant thread.

5. A leg guard for attachment to a boot comprising: an impact shell further comprising a shin guard section and a knee cup section, wherein the knee cup section is above the shin guard component, at least one pad attached to the inside surface of the impact shell component and an attachment clip removably fastened to the shin guard section for connecting the shin guard section to a top edge of the boot.

6. The leg guard of claim 5, wherein the shin guard is formed integrally with the knee cup section.

7. The leg guard of claim 5, wherein the shin guard is separately formed from the knee cup section.

8. The leg guard of claim 7, wherein the shin guard articulates separately from the knee cup as the user moves.

9. The leg guard of claim 5, further comprising at least one support rib provided at the shin guard.

10. The leg guard of claim 5, further comprising an attachment strap attached to the shin guard section adjacent to the lower end thereof for connecting to the boot.

11. The leg guard of claim 5 wherein the at least one pad is manufactured from Nomex.

12. The leg guard of claim 5, wherein the shin guard and knee cup are manufactured from a polymer blend.

13. The leg guard of claim 12, wherein the polymer blend comprises a combination of: polycarbonate, acrylonitrile, butadiene and styrene.

14. A leg guard for attachment to a boot comprising: a pad contoured to substantially conform to a user's shin and knee, an impact shell connected to the pad, wherein the impact shell further comprises a shin guard section contoured to the user's shin and a knee cup section contoured to the user's knee, and an attachment clip fastened to the shin guard section for connecting the shin guard section to a top edge of the boot.

15. The leg guard of claim 14 further comprising an attachment strap attached to the shin guard section adjacent to the lower end thereof for wrapping around the boot to further secure the shin guard to the boot.

16. The leg guard of claim 14, wherein the at least one pad is manufactured from Nomex.

17. The leg guard of claim 14, wherein the shin guard and knee cup are manufactured from a polymer blend.

18. The leg guard of claim 14 further comprising a plurality of adjustment holes formed through the shin guard portion for selectively positioning and securing the attachment clip.

19. The leg guard of claim 14, wherein the knee cup has a substantially flat section for contacting a surface.

20. The leg guard of claim 14, wherein the attachment clip is secured to the pad.

21. The leg guard of claim 14, wherein the knee cup and shin guard comprise separate pieces releasably connected with a fastener.

22. The leg guard of claim 14, wherein the shin guard is connected to the pad with a hook and loop fastener.

23. The leg guard of claim 21, wherein the fastener is a hook and loop fastener.

24. The leg guard of claim 14, wherein the knee cup is fixed to the pad and the shin guard is releasably connected to the pad.
